(19) United States
(12) Patent Application Publication
(10) Pub. No.: US 2004/0233146 A1
(43) Pub. Date: Nov. 25, 2004

(54) Selective window display

(76) Inventor: Don J. Nguyen, Portland, OR (US)

Correspondence Address: INTEL CORPORATION, P.O. BOX 5326, SANTA CLARA, CA, 95056-5326, US

(21) Appl. No.: 10/443,557

(22) Filed: May 21, 2003

(51) Int. Cl. G09G 3/32

(52) U.S. Cl. 345/82

(57) ABSTRACT

According to one embodiment of the present invention, a method of power management for a computer system using an organic light-emitting diode (OLED) display is disclosed. The method includes identifying a selected window and one or more non-selected windows. Picture elements (pixels) associated with the selected window are then enabled to emit light. Pixels associated with the one or more non-selected windows are prevented from emitting as much light as the pixels associated with the selected window.

### FIELD OF THE INVENTION

The present invention relates generally to field of power management. More specifically, the present invention relates to methods and apparatuses for controlling power consumption of displays.

### BACKGROUND

As more functionality is integrated into modern computer systems, the need to reduce power consumption becomes increasingly important, especially when the computer systems are mobile systems that operate on battery power. Users of mobile systems continuously expect longer battery life.

Mobile system designers try to address the need for longer battery life by implementing power management solutions that include reducing processor and chipset clock speeds, disabling unused components, and reducing power required by displays.

Typically, displays used with today's computer systems are liquid crystal displays (LCDs) of transmissive type. Transmissive LCDs require a light source to light the pixels. The light from the light source is sometimes referred to as a backlight as it is located in the back of the LCD. Power consumption of the LCD increases with the brightness of the backlight. In some computer systems, the backlight power consumption may be at approximately 4 Watts and may soar as high as 6 Watts when at its maximum luminance. There are many on-going efforts aimed at reducing the power consumption associated with the display.

### BRIEF DESCRIPTION OF THE DRAWINGS

The present invention is illustrated by way of example, and not limitation, in the figures of the accompanying drawings in which like references indicate similar elements and in which:

FIG. 1 is a block diagram illustrating an example of a computer system that may be used in accordance with an embodiment of the invention.

FIG. 2 illustrates an example of a liquid crystal display (LCD).

FIG. 3 illustrates an example of images displayed on a LCD.

FIG. 4 illustrates an example of an organic light-emitting diode (OLED) display.

FIG. 5 illustrates an example of an OLED display used with a selective window display technique, according to one embodiment.

FIG. 6 illustrates an example of an OLED display where non-selected windows are not as visible as a selected window, according to one embodiment.

FIG. 7 is a flow diagram illustrating an example of a process performed by OLED control logic, according to one embodiment.

FIG. 8 illustrates one example of a desktop having multiple visible windows displayed on an OLED display, according to one embodiment.

### DETAILED DESCRIPTION

For one embodiment, methods to reduce power consumption of a computer system having a display that includes picture elements (pixels) whose brightness is individually controlled are disclosed. The reduction of power consumption may be achieved by determining an area of the display that is of interest to a user.

In the following description, for purposes of explanation, numerous specific details are set forth to provide a thorough understanding of the present invention. It will be evident, however, to one skilled in the art that the present invention may be practiced without these specific details. In other instances, well known structures, processes, and devices are shown in block diagram form or are referred to in a summary manner in order to provide an explanation without undue detail.

### Computer System

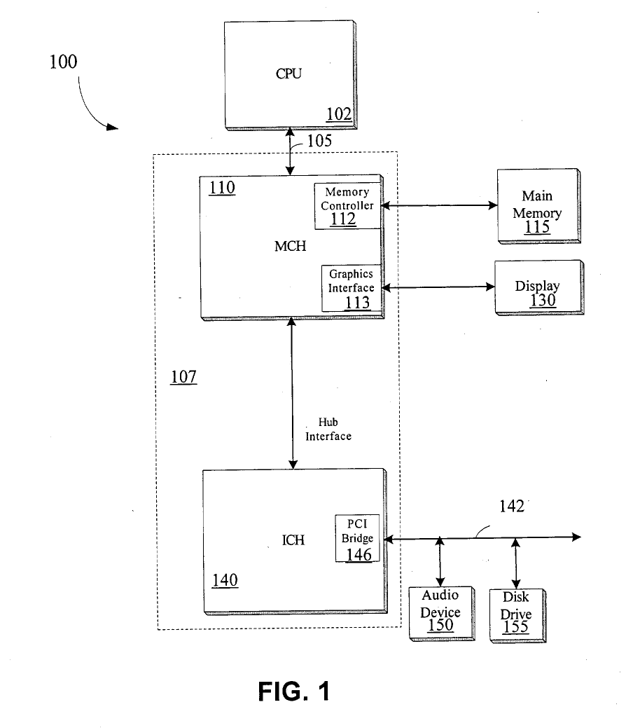

FIG. 1 is a block diagram illustrating an example of a computer system that may be used in accordance with an embodiment of the invention. Computer system 100 may include a central processing unit (CPU) 102 and may receive its power from an electrical outlet or a battery. The CPU 102 may be coupled to a bus 105. The CPU 102 may be a processor manufactured by, for example, Intel Corporation of Santa Clara, Calif. Chipset 107 may be coupled to the bus 105. The chipset 107 may include a memory control hub (MCH) 110. The MCH 110 may include a memory controller 112 that is coupled to system memory 115 (e.g., random access memory (RAM), read-only memory (ROM), etc.). The system memory 115 may store data and sequences of instructions that are executed by the CPU 102 or any other processing devices included in the computer system 100.

The MCH 110 may include a graphics interface 113. A display 130 may be coupled to the graphics interface 113. Typically, the display 130 is an LCD. For one embodiment, the display 130 is an display that includes picture elements (pixels) whose brightness may be individually controlled. For example, the display 130 may be an organic light-emitting diode (OLED) display. Although not shown, there may be logic to translate a digital representation of an image stored in a storage device such as video memory or system memory into display signals that may be interpreted and displayed by the display 130.

The chipset 107 may also include an input/output control hub (ICH) 140. The ICH 140 is coupled with the MCH 110 via a hub interface. The ICH 140 provides an interface to input/output (I/O) devices within the computer system 100. The ICH 140 may be coupled to a peripheral bus (e.g., Peripheral Component Interconnect (PCI) bus). Thus, the ICH 140 may include a PCI bridge 146 that provides an interface to a PCI bus 142. The PCI bridge 146 may provide a data path between the CPU 102 and peripheral devices. An audio device 150 and a disk drive 155 may be connected to the PCI bus 142. Although not shown, other devices (e.g., keyboard, mouse, etc.) may also be connected to the PCI bus 142.

### Liquid Crystal Display (LCD)

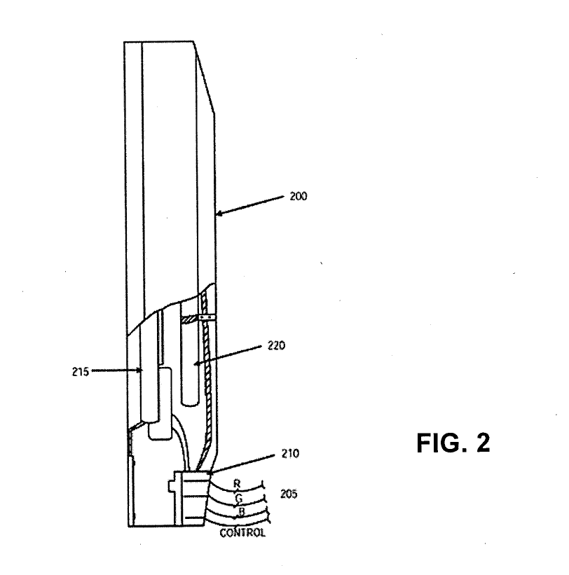

FIG. 2 illustrates an example of a liquid crystal display (LCD). LCD 200 may be an active-matrix (AM) thin-film-transistor (TFT) LCD. Display control signals 205 generated by logic associated with the graphics interface 113 may be interpreted by control device 210 and may subsequently be displayed by enabling pixels (not shown) on a screen 215. The pixels may be illuminated by backlight 220, the brightness of which may affect the brightness of the pixels and therefore the brightness of the image being displayed. The backlight 220 may be a fluorescent tubes located behind the screen 215 or at the edge along the length of screen 215.

The LCD 200 may offer display quality at different resolution. For example, the LCD 200 may display images at resolution 1024×768 pixels per horizontal and vertical line or lower. Each pixel may be composed of three sub-pixels or dots that, when enabled, cause a red, green, and blue (RGB) color to be displayed, respectively. Each sub-pixel color may vary according to a combination of bits representing each sub-pixel. The number of bits representing a sub-pixel may determine the number of colors, or color depth or grayscales that may be displayed by a sub-pixel. Each sub-pixel may consist of one liquid crystal (LC) and may be accessed by a row and column position. An LC is non-emissive. This means that the LC needs light from a light source such as the backlight 220. An LC is also a capacitor and may respond to alternating voltages. The voltage supplied to the LC may determine the intensity of light that passes through from the backlight 220. LCD technology is known to one skilled in the art.

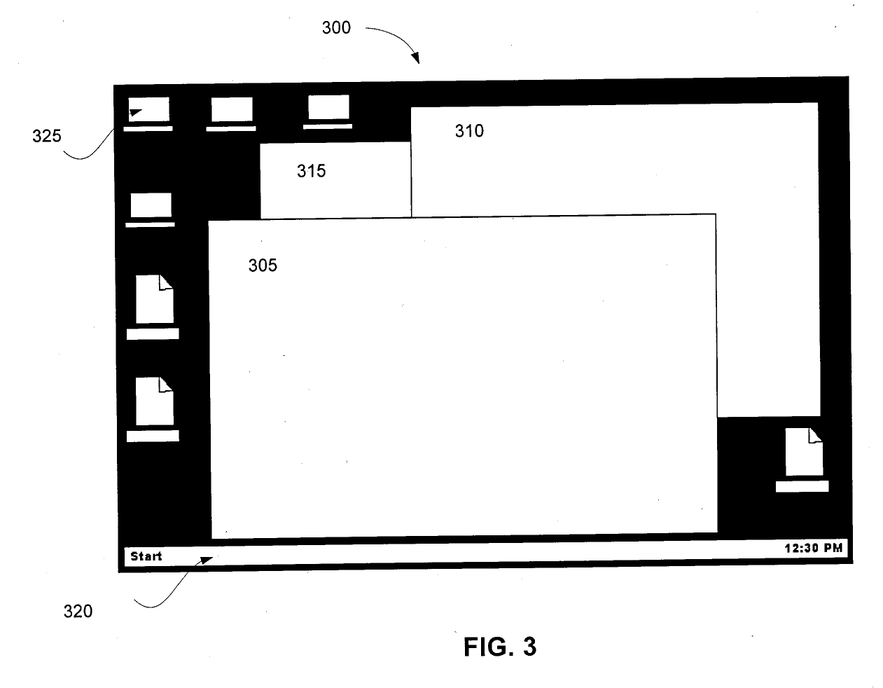

FIG. 3 illustrates an example of images displayed on a screen of a LCD. Screen 300 may be associated with the LCD 200 illustrated in FIG. 2 and the computer system 100 illustrated in FIG. 1. For one embodiment, the computer system 100 may be configured to operate with a window-based operating system (OS) such as, for example, Microsoft Windows XP manufactured by Microsoft Corporation of Redmond, Washington. The screen 300 may display a desktop having multiple open windows 305, 310, and 315. The desktop may include icons relating to applications, folders, etc. such as, for example, icon 325. The desktop may also include other information such as, for example, the start bar 320.

Typically, whenever the backlight 220 is on, the light may be distributed uniformly across the screen 300 (and to all of the LCs). The brightness of the backlight 220 may remain the same even though a user of the computer system 100 may not be interested in viewing certain areas of the screen 300. Referring to FIG. 3, even though the windows 305, 310 and 315 are open, the window 305 is at the foreground because it has been selected by a user. Thus, it may be likely that the user may be more interested in the information displayed in the window 305 than information displayed elsewhere. However, because it is not possible to control the backlight 220 to distribute light in different areas of the screen 300, the windows 310 and 315 are as visible and bright as the window 305, except for the overlapping areas. This may be undesirable because power may be wasted. One technique of reducing the power consumption associated with a LCD such as the LCD 200 includes decreasing the brightness of the backlight 220. However, reducing the brightness of the backlight 220 may affect the quality of the image being displayed. The quality of the image may also suffer when the brightness of the backlight 220 is dimmer than ambient light surrounding the LCD 200.

### Organic Light-Emitting Diode (OLED) Display

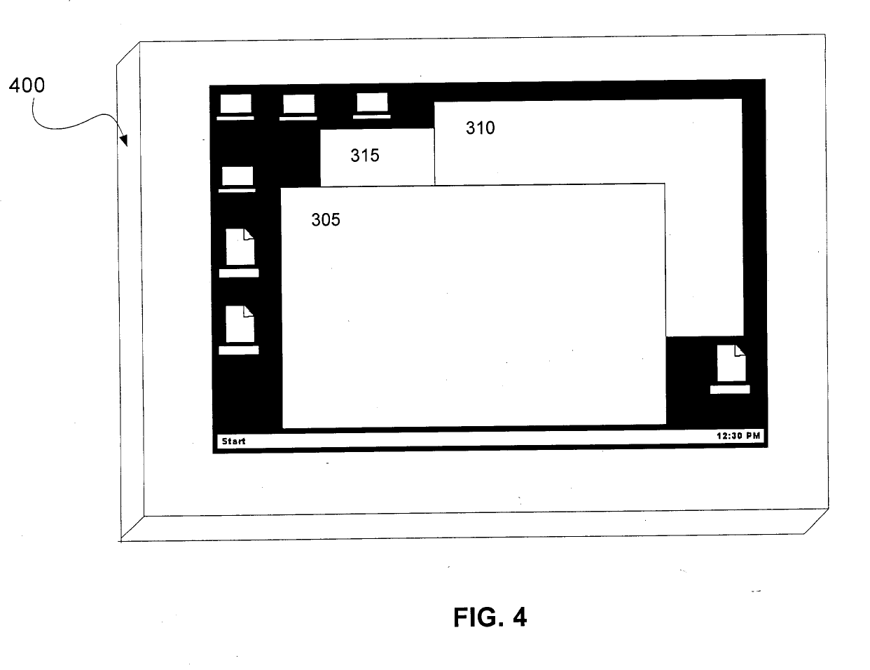

FIG. 4 illustrates an example of an OLED display. OLED is a technology developed by the Eastman Kodak Company of Rochester, N.Y. OLED display 400 may display the desktop as illustrated in FIG. 3. The desktop may have open windows 305, 310 and 315. The OLED display 400 may consist of thin layers of individual carbon-based pixels (not shown) that emit light (self-luminous pixels) when an electric current passes through them. There is no requirement to have a backlight as is typically used in LCDs. This may enable the OLED display 400 to be thinner and lighter than displays manufactured using other display technologies.

Because the current passing through each of the pixels may be controlled, each pixel may emit light independently of the others. This may be desirable because the power consumption may occur mostly by the pixels that are turned on (i.e., emit light). Those pixels that are turned off (i.e., not emit light) may not consume any power. As a result, when the OLED display 400 is used with a mobile computer system, the overall power consumption may be reduced. OLED technology is known to one skilled in the art.

### Selective Window Display on OLED Display

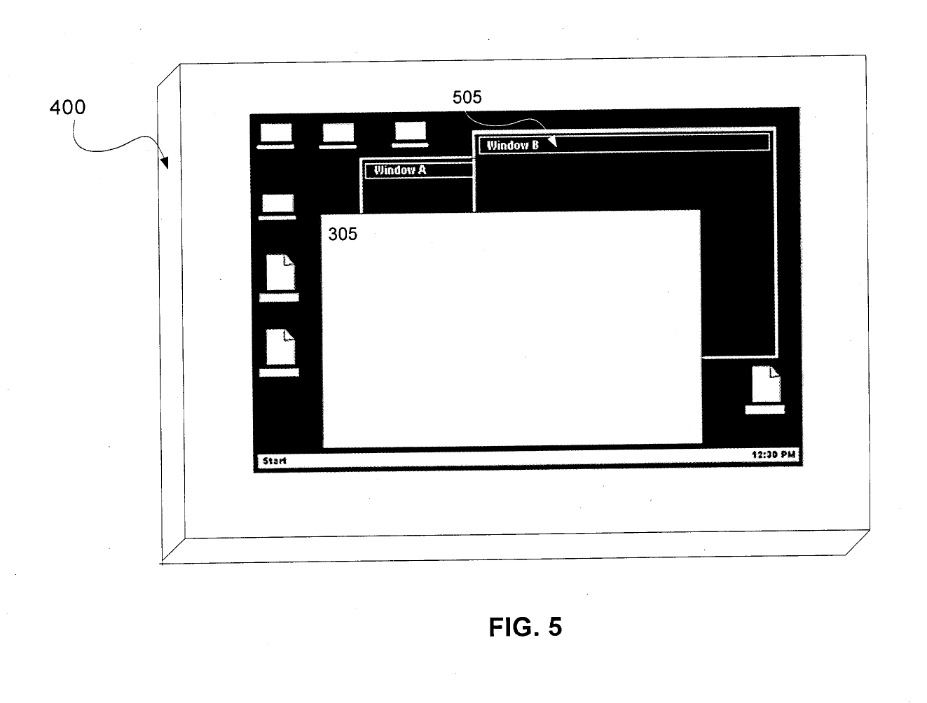

FIG. 5 illustrates an example of an OLED display used with a selective window display technique, according to one embodiment. As described in the example of FIG. 3, the desktop may include multiple open windows 305, 310 and 315. The window-based OS (e.g., Windows XP, etc.) may keep track of which window is currently selected (e.g., window 305) such that the selected widow may be brought to the foreground. The window-based OS may also keep track of the open windows that are not selected (e.g., windows 310 and 315).

OLED control logic (not shown) may be used to control the pixels of the OLED display 400. For one embodiment, the OLED control logic may receive information associated with the selected window (e.g., window 305) and with the non-selected window(s) (e.g., windows 310, 315) from the window-based OS. The OLED control logic may then enable pixels associated with the selected window to emit light. The OLED control logic may further prevent some or all of the pixels associated with the non-selected window(s) from emitting light. For example, referring to FIG. 5, the selected window 305 is visible while portions of the non-selected windows 310 and 315 may not be visible.

The OLED control logic may allow certain pixels associated with the non-selected window(s) to emit light so that these windows may remain somewhat visible for a user to select them when necessary. In this example, the border portions of the non-selected windows 310 and 315 may remain visible. Portions of the non-selected windows that identify what they are may also remain visible to the user. This may include, for example, the title bar 505 displayed along the top of the non-selected windows.

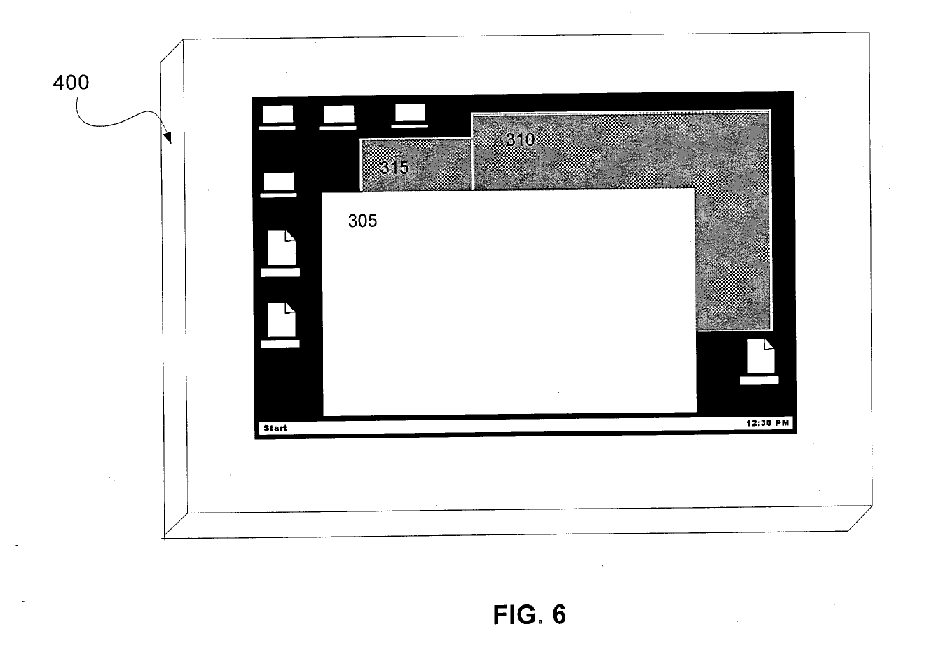

For one embodiment, instead of preventing most of the pixels associated with the non-selected window(s) from emitting light, the OLED control logic may reduce the amount of current applied to these pixels so that the light that they emit may not be as bright as the pixels associated with the selected display. This is illustrated in the example of FIG. 6 where the non-selected windows 310 and 315 are visible but not are bright as the selected window 305.

### Selective Window Display Process

For one embodiment, the OLED control logic may be implemented in software (e.g., a display driver) and may be used when the computer system 100 is configured with an OLED display. Alternatively, the OLED control logic may be implemented in hardware or a combination of software and hardware.

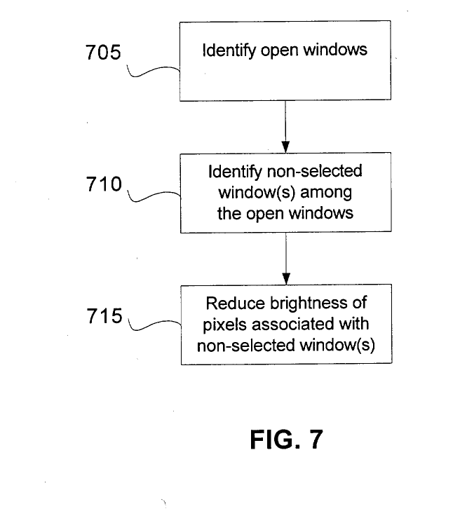

FIG. 7 is a flow diagram illustrating an example of a process performed by the OLED control logic, according to one embodiment. The OLED control logic may be used with an OLED display in a computer system configured to operate with a window-based O.S. A user using the computer system may open a new window, in which case the new window may be displayed in the foreground. Alternatively, the user may select a window that is already open, in which case the open window is also brought to the foreground. In either situation, a signal may be sent to the OS to indicate that a window is selected.

At block 705, all open windows are identified. It may be possible that there may be multiple open windows. Some of the windows may overlap one another, while some others may not. Alternatively, there may only be one open window, in which case the open window may be the same as the selected window.

Typically, the selected window may be displayed in the foreground. At block 710, the non-selected windows are identified. Typically, the non-selected windows may be wholly or partially overlapped by one or more other windows, including the selected window. It may be possible to have a non-selected window not being overlapped by any other windows. For one embodiment, there may only be one selected window.

At block 715, the OLED control logic may identify pixels associated with the identified non-selected windows and may prevent those pixels from emitting light. Alternatively, the OLED control logic may cause those pixels to emit less light such that the non-selected windows may not be as visible or as bright as the selected window.

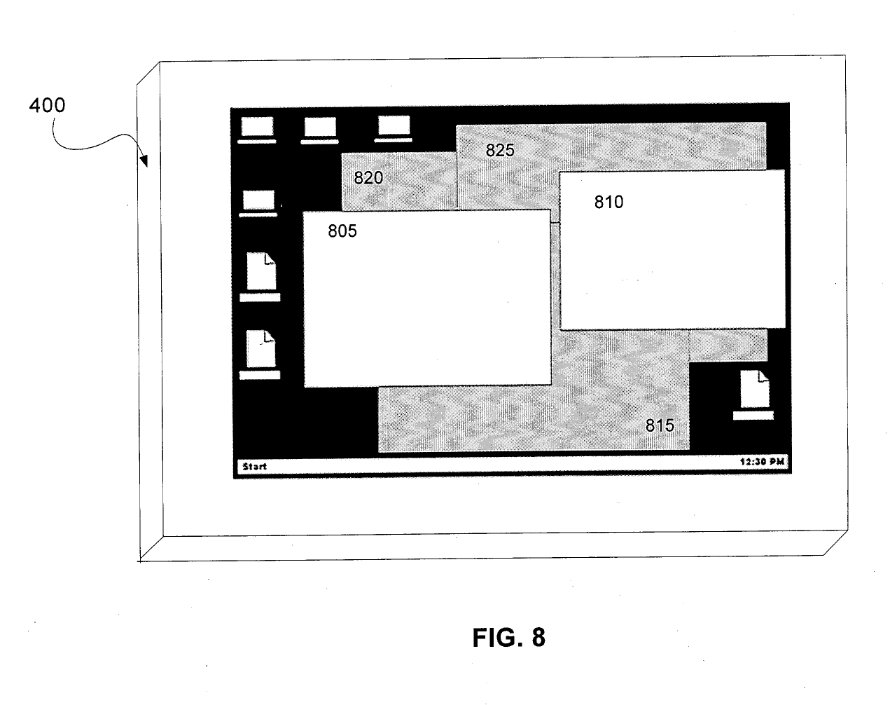

FIG. 8 illustrates one example of a desktop that may be displayed on an OLED display. In this example, the windows 805 and 810 are wholly visible and not overlapped by any other windows. The windows 815, 820 and 825 are partially overlapped. Even though there may only be one selected window (e.g., window 805), it may be possible that the window 810 is not overlapped by any other window because the user wants to be able to view the entire window 810. For one embodiment, in addition to enabling the pixels associated with the selected window 805 to emit light, the OLED control logic may also enable the pixels associated with the non-selected and non-overlapped window 810 to emit light. The power consumption may still be reduced by reducing the amount of light emitted by the pixels associated with the non-selected and overlapped windows 815, 820 and 825.

Although the techniques described above refer to selected and non-selected windows, one skilled in the art will recognize that the techniques may also be used with other criteria other than or in addition to the selected and non-selected windows to control the brightness of the pixels. For example, the user may specify a certain display preference and the OLED control logic may control the brightness of the pixels based on the user's display preference. Furthermore, although the descriptions refer to the OLED displays, one skilled in the art will recognize that other displays implemented with display technologies that allow pixels to be individually controlled, including controlling the brightness of each pixel, may also be used.

The operations of these various techniques may be implemented by a processor in a computer system such as, for example, computer system 100 illustrated in FIG. 1, which executes sequences of computer program instructions that are stored in a memory (e.g., memory 115) which may be considered to be a machine-readable storage media. The memory may be RAM, ROM, a persistent storage memory, such as mass storage device or any combination of these devices. Execution of the sequences of instruction may cause the processor to perform operations according to the process described in FIG. 7, for example.

The instructions may be loaded into memory of the computer system from a storage device or from one or more other computer systems (e.g. a server computer system) over a network connection. The instructions may be stored concurrently in several storage devices (e.g. RAM and a hard disk, such as virtual memory). Consequently, the execution of these instructions may be performed directly by the processor. In other cases, the instructions may not be performed directly or they may not be directly executable by the processor. Under these circumstances, the executions may be executed by causing the processor to execute an interpreter that interprets the instructions, or by causing the processor to execute a compiler which converts the received instructions to instructions that which can be directly executed by the processor. In other embodiments, hard-wired circuitry may be used in place of or in combination with software instructions to implement the present invention. Thus, the present invention is not limited to any specific combination of hardware circuitry and software, or to any particular source for the instructions executed by the computer system.

Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

1. A method, comprising:
enabling picture elements (pixels) associated with a selected window to emit light; and
when there is one or more non-selected windows, not enabling pixels associated with the one or more non-selected windows to emit as much light as the pixels associated with the selected window, wherein the selected window and the one or more non-selected windows are displayed on a display having pixels whose brightness can be individually controlled.

2. The method of claim 1, further comprising:
identifying all windows displayed on the display; and
identifying the selected window from all of the windows displayed on the display.

3. The method of claim 1, wherein not enabling the pixels associated with the one or more non-selected windows to emit as much light as the pixels associated with the selected window includes preventing the pixels associated with the one or more non-selected windows from emitting light.

4. The method of claim 1, wherein not enabling the pixels associated with the one or more non-selected windows to emit as much light as the pixels associated with the selected window includes preventing a portion of the pixels associated with the one or more non-selected windows from emitting light.

5. The method of claim 1, wherein the display is used with a computer system configured with a window-based operating system.

6. The method of claim 1, wherein the display is an organic light-emitting diode (OLED) display.

7. A method, comprising:
using a display having picture elements (pixels) that can be controlled to emit light independently of other pixels to display information in a computer system configured with a window-based operating system (OS);
identifying a first group of window that includes one or more windows wholly visible on the display; and
enabling pixels associated with the first group of window to emit light.

8. The method of claim 7, wherein the first group of window includes a selected window.

9. The method of claim 8, wherein the selected window is displayed in a foreground.

10. The method of claim 7, further comprising:
identifying a second group of window that includes one or more windows not wholly visible on the display.

11. The method of claim 10, further comprising:
not enabling pixels associated with the second group of window to emit light.

12. The method of claim 10, further comprising:
enabling pixels associated with the second group of window to emit less light as compared to light emitted by the pixels associated with the first group of window.

13. The method of claim 7, wherein the display is an organic light-emitting diode (OLED) display.

14. A system comprising:
a processor;
a chipset coupled to the processor;
a display coupled to the chipset, wherein the display includes technology that enables picture elements (pixels) on the display to emit light independently of other pixels; and
a display control logic coupled to the display, wherein the display control logic is to enable the pixels of the display to emit light in a first area of the display and to emit less light in a second area of the display.

15. The system of claim 14, wherein the processor is to operate with a window-based operating system (OS).

16. The system of claim 15, wherein the first area of the display includes a selected window.

17. The system of claim 15, wherein the second area of the display includes one or more non-selected windows.

18. The system of claim 14, wherein the display control logic is to enable the pixels of the display to emit no light in the second area.

19. The system of claim 14, wherein the display is an organic light-emitting diode (OLED) display.

20. An apparatus, comprising:
logic to identify a selected window displayed on an organic light-emitting diode (OLED) display and to enable picture elements (pixels) associated with the selected window to emit light.

21. The apparatus of claim 20, further comprising:
logic to identify one or more non-selected windows displayed on the OLED display and to prevent pixels associated with the one or more non-selected windows to emit as much light as the pixels associated with the selected window.

22. The apparatus of claim 20, wherein the OLED display displays information controlled by a window-based operating system.

23. An article of manufacture comprising:
a machine readable medium that provides instructions that, if executed by a machine, will cause the machine to perform operations including:
enabling picture elements (pixels) associated with a selected window to emit light; and
when there is one or more non-selected windows, not enabling pixels associated with the one or more non-selected windows to emit as much light as the pixels associated with the selected window, wherein the selected window and the one or more non-selected windows are displayed on a display having pixels whose brightness can be individually controlled.

24. The article of manufacture of claim 23, further comprising:
identifying all windows displayed on the display; and
identifying the selected window from all of the windows displayed on the display.

25. The article of manufacture of claim 23, wherein not enabling the pixels associated with the one or more non-selected windows to emit as much light as the pixels associated with the selected window includes preventing the pixels associated with the one or more non-selected windows from emitting light.

26. The article of manufacture of claim 23, wherein not enabling the pixels associated with the one or more non-selected windows to emit as much light as the pixels associated with the selected window includes preventing a portion of the pixels associated with the one or more non-selected windows from emitting light.

27. The article of manufacture of claim 23, wherein the display is used with a computer system configured with a window-based operating system.

28. The article of manufacture of claim 23, wherein the display is an organic light-emitting diode (OLED) display.

29. A method, comprising:
enabling picture elements (pixels) associated with a first area of a display screen to emit light at a first brightness level; and
enabling pixels associated with a second area of the display screen to emit light at a second brightness level, wherein the brightness of the pixels associated with the first area and with the second area can be individually controlled.

30. The method of claim 29, wherein the first brightness level is brighter than the second brightness level.

31. The method of claim 29, wherein the first area of the display screen includes one or more areas identified as areas of interest.

32. The method of claim 29, wherein the first area of the display screen includes an area associated with a selected window when the display screen includes information managed by a window-based operating system.

33. The method of claim 32, wherein the second area of the display screen includes an area associated with one or more non-selected window.

34. The method of claim 29, wherein the second area of the display screen includes one or more areas not identified as areas of interest.

35. A system, comprising:
a display control logic to individually control picture elements (pixels) of a display such that a first set of pixels emit light at a first brightness level and a second set of pixels emit light at a second brightness level.

36. The system of claim 35, wherein the first set of pixels is associated with a selected window when information displayed on the display is managed by a window-based operating system (OS).

37. The system of claim 36, wherein the second set of pixels is associated with one or more non-selected windows.

38. The system of claim 35, wherein the first brightness level is brighter than the second brightness level.

39. The system of claim 38, wherein the second brightness level includes zero illumination.

40. The system of claim 35, wherein the display is an organic light-emitting diode (OLED) display.
